(19) United States
(12) Patent Application Publication
(10) Pub. No.: US 2025/0223387 A1
(43) Pub. Date: Jul. 10, 2025

(54) SELF-HEALING COPOLYMERS

(71) Applicant: Northwestern University, Evanston, IL (US)

(72) Inventors: John Mark Torkelson, Skokie, IL (US); Tong Wang, Evanston, IL (US)

(21) Appl. No.: 19/014,598

(22) Filed: Jan. 9, 2025

Related U.S. Application Data
(60) Provisional application No. 63/619,423, filed on Jan. 10, 2024.

(51) Int. Cl. C08F 212/08; C08F 220/18; C09D 125/14; C09D 133/06

(52) U.S. Cl. CPC C08F 212/08; C08F 220/1806; C08F 220/1808; C09D 125/14; C09D 133/062; C08F 2800/10

(57) ABSTRACT

Provided are random copolymers exhibiting the ability to self-heal, including under ambient conditions (room temperature and atmospheric pressure). Compositions comprising the random copolymers are also provided. The self-healing, random copolymer is a polymerization product of monomers comprising a branched alkyl (meth)acrylate and a comonomer, wherein the branched alkyl (meth)acrylate is present at an amount of at least 40 mol %.

### CROSS-REFERENCE TO RELATED APPLICATIONS

The present application claims priority to U.S. provisional patent application No. 63/619,423 that was filed Jan. 10, 2024, the entire contents of which are incorporated herein by reference.

### BACKGROUND

Some polymer materials capable of autonomous self-healing have been developed. The categorization of self-healing materials into extrinsic and intrinsic types has been instrumental in understanding their mechanisms and properties. Extrinsic self-healing mechanisms involve pre-embedding reactive encapsulated fluids within the material matrix. These fluid vesicles burst open and react upon damage, filling and sealing the cracks or voids to restore the integrity of the original material. In contrast, intrinsic self-healing mechanisms take advantage of physical or chemical dynamic interactions within the polymer matrix. These interactions enable the material to repair damage by redistributing or reconnecting polymer chains, either autonomously or under a specific stimulus. The distinction between extrinsic and intrinsic self-healing materials extends beyond their mechanisms to their respective strengths and limitations. Intrinsic self-healing materials exhibit superior versatility and resilience compared to their extrinsic counterparts due to their inherent ability to heal multiple times and withstand various types of damage.

### SUMMARY

Provided are random copolymers exhibiting the ability to self-heal, including under ambient conditions (room temperature and atmospheric pressure). Compositions comprising the random copolymers are also provided.

The Example below describes the synthesis and testing of an illustrative random copolymer, poly(styrene-r-2-ethylhexyl acrylate) (P(S/EHA)), which showcases self-healing across an unexpectedly wide, 45/55 to 70/30 mol ratio composition range, with T_{g}s ranging from −25° C. to 14° C. and copolymer chains in either entangled and unentangled states. The Example further compares P(S/EHA) to poly(styrene-r-n-hexyl acrylate) (P(S/nHA)), the latter exhibiting room-temperature self-healing only at a 45/55 composition and with molecular weights below the entanglement threshold. Infrared spectroscopy highlights the reorientation and reconfiguration of EHA units during self-healing. Thermal analysis underscores enhanced dynamic heterogeneity in P(S/EHA) compared to P(S/nHA), indicative of special associations formed by EHA units. Both analyses support the hypothesis that ethylhexyl groups in EHA side chains on different copolymers experience substantial van der Waals forces, interdigitating and forming ‘key-and-lock’ associations between chains.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings, wherein like numerals denote like elements.

FIG. 1A shows optical images of damaged 45/55 P(S/EHA) copolymer film with Mₙ=55 kg/mol that was self-healed for 0 h (panel 1) and 1 h (panel 2). FIG. 1B shows optical images of damaged 56/44 P(S/EHA) copolymer film with Mₙ=50 kg/mol that was self-healed for 0 h (panel 1) and 10 h (panel 2). FIG. 1C shows optical images of damaged 69/31 P(S/EHA) copolymer film with Mₙ=44 kg/mol that was self-healed for 0 h (panel 1) and 30 h (panel 2). FIG. 1D shows optical images of damaged 45/55 P(S/nHA) copolymer film with Mₙ=62 kg/mol that was self-healed for 0 h (panel 1) and 3 h (panel 2). FIG. 1E shows optical images of damaged 56/44 P(S/nHA) copolymer film with Mₙ=49 kg/mol that was self-healed for 0 h (panel 1) and 100 h (panel 2). FIG. 1F shows optical images of damaged 68/32 P(S/nHA) copolymer film with Mₙ=53 kg/mol that was self-healed for 0 h (panel 1) and 100 h (panel 2). Films were self-healed under ambient conditions.

FIGS. 2A-2C show images of 69/31 P(S/EHA) sample as (FIG. 2A) original (FIG. 2B) damaged and (FIG. 2C) self-healed film (at ambient condition for 30 h). FIG. 2D shows an image of 30 h self-healed film withstanding a 300 g weight (0.5 MPa stress) FIG. 2E shows an image of an original film, FIG. 2F shows an image of a damaged film, and FIG. 2G shows an image of a self-healed film (at ambient condition for 30 h). FIG. 2H shows an image of a 30 h self-healed film withstanding a strain ˜230%. The 69/31 P(S/EHA) has Mₙ=44 kg/mol.

FIGS. 3A-3D show stress-strain curves of original copolymer films and copolymer films that were damaged and allowed to self-heal for different time periods for (FIG. 3A) 56/44 P(S/EHA) with Mₙ=50 kg/mol, (FIG. 3B) 56/44 P(S/nHA) with Mₙ=49 kg/mol, (FIG. 3C) 69/31 P(S/EHA) with Mₙ=44 kg/mol and (FIG. 3D) 68/32 P(S/nHA) with Mₙ˜53 kg/mol. Films were self-healed under ambient conditions.

FIG. 4A shows optical images of damaged 51/49 P(S/EHA) copolymer film with Mₙ=206 kg/mol that was self-healed for 0 h (panel 1) and 30 h (panel 2). FIG. 4B shows optical images of damaged 70/30 P(S/EHA) copolymer film with Mₙ=169 kg/mol that was self-healed for 0 h (panel 1) and 30 h (panel 2). FIG. 4C shows optical images of damaged 52/48 P(S/nHA) copolymer film with Mₙ=163 kg/mol that was self-healed for 0 h (panel 1) and 200 h (panel 2). FIG. 4D shows optical images of damaged 70/30 P(S/nHA) copolymer film with Mₙ=137 kg/mol that was self-healed for 0 h (panel 1) and 200 h (panel 2). Films were self-healed under ambient conditions.

FIGS. 5A-5D show stress-strain curves of original copolymer films and copolymer films that were damaged and allowed to self-heal for different time periods for (FIG. 5A) 51/49 P(S/EHA) with Mₙ=206 kg/mol, (FIG. 5B) 52/48 P(S/nHA) with Mₙ=163 kg/mol, (FIG. 5C) 70/30 P(S/EHA) with Mₙ=169 kg/mol and (FIG. 5D) 70/30 P(S/nHA) with Mₙ=137 kg/mol. Films were self-healed under ambient conditions.

FIGS. 6A-6F show FT-IR spectra acquired in intact materials and damaged materials after various lengths of self-healing test time in the 1100-1280 cm⁻¹ region for (FIG. 6A) 69/31 P(S/EHA) with Mₙ=44 kg/mol and (FIG. 6B) 68/32 P(S/nHA) with Mₙ=53 kg/mol, in the 1630-1800 cm⁻¹ region for (FIG. 6C) 69/31 P(S/EHA) with Mₙ=44 kg/mol and (FIG. 6D) 68/32 P(S/nHA) with Mₙ=53 kg/mol and in the 1720-1735 cm⁻¹ region for (FIG. 6E) 69/31 P(S/EHA) with Mₙ=44 kg/mol and (FIG. 6F) 68/32 P(S/nHA) with Mₙ=53 kg/mol. Films were allowed to self-heal under ambient conditions.

FIG. 7A shows normalized derivative DSC heating curves for 69/31 P(S/EHA) with Mₙ=44 kg/mol and 68/32 P(S/nHA) with Mₙ=53 kg/mol. The linear bar below the curve indicates the T_{g,breadth} determined from the derivative heat flow. FIG. 7B shows T_{g,breadth} as a function of styrene content for P(S/EHA) and P(S/nHA). Copolymers are low MW materials (44 kg/mol<Mₙ<62 kg/mol).

FIG. 8 shows the chemical formula of random copolymers according to the present disclosure.

FIGS. 9A and 9B show the three-dimensional reconstruction from white light interferometry of damaged Mₙ=45 kg/mol 69/31 P(S/EHA) copolymer film that was self-healed at room temperature for (FIG. 9A) 0 h and (FIG. 9B) 30 h.

### DETAILED DESCRIPTION

Provided are random copolymers exhibiting the ability to self-heal, including under ambient conditions (room temperature and atmospheric pressure). Compositions comprising the random copolymers are also provided.

The random copolymers are formed by polymerizing (e.g., via free radical polymerization) a branched alkyl (meth)acrylate and a comonomer. Thus, the random copolymers are the polymerization product of the branched alkyl (meth)acrylate and the comonomer. The branched alkyl (meth)acrylate may be represented by the chemical formula H₂CCR₁C(O)OR₂, wherein R₁ is hydrogen or methyl and R₂ is a branched (as distinguished from linear and cyclic) alkyl. The branched alkyl may have from 6 to 12 carbon atoms. The includes the branched alkyl having 6, 7, 8, 9, 10, 11, or 12 carbon atoms. The branched alkyl may contain a single branch, i.e., a single tertiary carbon atom. The position of the branch in the branched alkyl may be on the second carbon atom (the first carbon atom being that covalently bound to the oxygen of the (meth)acrylate group). The branched alkyl may be unsubstituted which means the branched alkyl contains no heteroatoms, i.e., only carbon and hydrogen are present. Illustrative branched alkyls include 2-ethylhexyl and 2-propylheptyl. Illustrative branched alkyl (meth)acrylates include 2-ethylhexyl acrylate, 2-ethylhexyl methacrylate, 2-propylheptyl acrylate, and 2-propylheptyl methacrylate. A single species of branched alkyl (meth)acrylate may be used (e.g., only 2-ethylhexyl acrylate is used) or multiple, different species may be used (e.g., both 2-ethylhexyl acrylate and 2-propylheptyl acrylate may be used).

A comonomer is used to polymerize with the selected branched alkyl (meth)acrylate to form the random copolymer. The comonomer is not a branched alkyl (meth)acrylate, but otherwise a variety of comonomers capable of copolymerizing with the selected branched alkyl (meth)acrylate may be used. This includes comonomers which comprise a vinyl group. The phrase “vinyl group” refers to both —C(H)CH₂ and —C(CH₃)CH₂, wherein “-” refers to the bond to the remainder of the comonomer. Illustrative comonomers include styrene, 4-methylstyrene, (meth)acrylates, vinyl pyridine, acrylamides, vinyl acetate, and vinyl alkyl ether. Each of these comonomers comprises a vinyl group bound to another moiety, i.e., either phenyl (styrene/4-methylstyrene), ester ((meth)acrylate), pyridine (vinyl pyridine), amide (acrylamide), acetate (vinyl acetate), or alkoxy (vinyl alkyl ether). A single species of comonomer may be used (e.g., only styrene is used) or multiple, different species may be used (e.g., both styrene and a (meth)acrylate may be used).

The amount of the branched alkyl (meth)acrylate in the random copolymer is selected to achieve the self-healing behavior described herein. However, by contrast to existing self-healing polymers, a broad range of amounts of the branched alkyl (meth)acrylate may be used. For example, the amount of the branched alkyl (meth)acrylate in the random copolymer may be at least 40 mol %, at least 45 mol %, at least 50 mol %, at least 55 mol %, at least 60 mol %, at least 65 mol % or at least 70 mol %. The amount may be a range of from any of these values up to 75 mol %, e.g., from 40 mol % to 75 mol %. These amounts refer to the total moles of the branched alkyl (meth)acrylate(s) used in forming the random copolymer as compared to the total moles of all monomers used in forming the random copolymer. These amounts refer to the amounts of the monomers which have been incorporated into the random copolymer through the polymerization reactions. These amounts may be measured using NMR spectroscopy as described in the Example below. If more than one species of branched alkyl (meth)acrylate (and/or if more than one species of comonomer) are used, these amounts refer to the total moles of all species used. As further described below, the amount of the branched alkyl (meth)acrylate may also be selected to achieve a desired glass transition temperature (T_{g}) for the random copolymer. The balance of the composition of the random copolymer is composed of the selected comonomer(s). (This does not preclude the presence of an initiator (or portion thereof) or require absolute chemical purity as further described below.)

The composition of the random copolymers depends upon the selection of the branched alkyl (meth)acrylate(s) and the comonomer(s) and their relative amounts, as well as the polymerization reactions between selected monomers that produce the polymerization product (i.e., the random copolymer) as described above. As noted above, the polymerization reactions may be free radical polymerization reactions induced under conditions such as those described in the Example, below. Thus, a variety of compositions of random copolymers are encompassed, including those based on various polymerization products of reactants comprising various combinations of branched alkyl (meth)acrylate(s) and comonomer(s). For clarity, the composition of the random copolymers may be identified by reference to the monomers which are polymerized, recognizing that the chemical form of those monomers is generally altered as a result of the polymerization reactions. Once polymerized in the random copolymers, monomers may be referred to as “polymerized monomers.” For clarity, the composition of the random copolymers may be further identified by reference to the relative amounts of the monomers used to form the random copolymer as described above.

Illustrative random copolymers include those which are the polymerization product of monomers comprising (or consisting of) 2-ethylhexyl acrylate and styrene; 2-ethylhexyl acrylate and 4-methylstyrene; 2-ethylhexyl acrylate and a (meth)acrylate; 2-propylheptyl acrylate and styrene; 2-propylheptyl acrylate and 4-methylstyrene; 2-propylheptyl acrylate and a (meth)acrylate; 2-ethylhexyl acrylate, styrene, and a (meth)acrylate; 2-ethylhexyl acrylate, 4-methylstyrene, and a (meth)acrylate. Here, “consisting” does not preclude the presence of an initiator (or a portion thereof) in the random copolymer. Similarly, here, “consisting” does not require absolute chemical purity due to the inherent nature of the synthetic technique used to provide the random copolymer (e.g., free radical polymerization).

Using a specific, illustrative composition, the composition of the random copolymer may be identified as poly(styrene-r-2-ethylhexyl acrylate). In this description, the different chemical moieties which result from the polymerization reactions are identified by reference to the corresponding monomer and “r” refers to the random incorporation of the different monomers into the copolymer. The use of this description encompasses the presence of an initiator (or portion thereof) and does not require absolute chemical purity.

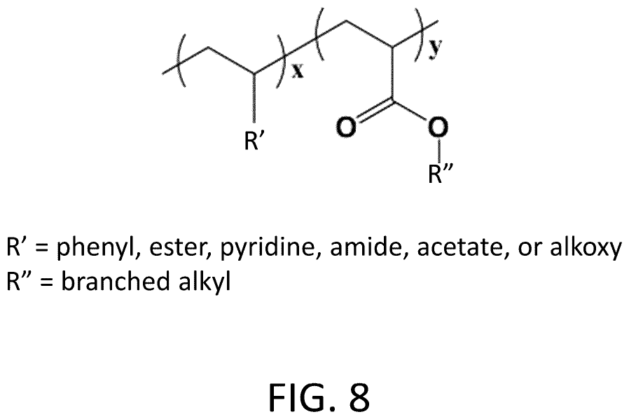

FIG. 8 shows a chemical formula which may be used to represent the disclosed random copolymers, wherein x refers to the mol % of the comonomer and y refers to the mol % of the branched alkyl (meth)acrylate. If more than one type of comonomer and/or more than one type of branched alkyl (meth)acrylate is present, they may be included in the chemical formula as additional repeating units analogous to that shown in FIG. 8, illustrating use of a single type of comonomer and a single type of branched alkyl (meth)acrylate. The formula of FIG. 8 encompasses random copolymers in which more than one type of comonomer and/or more than one type of branched alkyl (meth)acrylate is present. The present random copolymers, including those having the chemical formula shown in FIG. 8 are not polypeptoids.

Regarding the various groups and moieties disclosed herein with respect to the comonomer, “alkyl” refers to a linear, branched, or cyclic alkyl group in which the number of carbons may range from, e.g., 1 to 12, 1 to 8, 1 to 6, 1 to 4, 1 to 3, or 1 to 2. (However, “branched alkyl” as in the disclosed “branched alkyl (meth)acrylate” is as defined above.) A cyclic alkyl group may be referred to as a cycloalkyl group. The alkyl group may be unsubstituted, by which it is meant the alkyl group contains no heteroatoms. An unsubstituted alkyl group encompasses an alkyl group in which one or more bonds to a carbon(s) or hydrogen(s) are replaced by a bond to an unsubstituted aromatic ring, e.g. benzyl. The alkyl group may be substituted, by which it is meant an unsubstituted alkyl group in which one or more bonds to a carbon(s) or hydrogen(s) are replaced by a bond to non-hydrogen and non-carbon atoms

The term “phenyl” refers to —C₆H₅, wherein “-” denotes the bond to the vinyl group of the comonomer. The phenyl may be unsubstituted or substituted as described above with respect to alkyl groups. An unsubstituted phenyl group includes phenyl in which one or more bonds to a carbon(s) or hydrogen(s) are replaced by a bond to an unsubstituted alkyl, e.g., methyl.

The term “ester” refers to —C(O)OR, wherein R is an alkyl group and “-” denotes the bond to the vinyl group of the comonomer. Thus, “(meth)acrylate” encompasses methyl (meth)acrylate, ethyl (meth)acrylate, propyl (meth)acrylate, butyl (meth)acrylate, isobutyl (meth)acrylate, etc.

The term “pyridine” refers to —C₅H₅N, wherein “-” denotes the bond to the vinyl group of the comonomer. The pyridine may be unsubstituted or substituted as described above with respect to alkyl groups.

The term “amide” refers to —C(O)NR₂, wherein each R is independently selected from hydrogen and alkyl groups and “-” denotes the bond to the vinyl group of the comonomer.

The term “acetate” refers to —OC(O)CH₃, wherein “-” denotes the bond to the vinyl group of the comonomer.

The term “alkoxy” refers to —OR, wherein R is an alkyl group and “-” denotes the bond to the vinyl group of the comonomer.

Regarding substituents in the groups and moieties described herein (as opposed to unsubstituted groups), non-hydrogen and non-carbon atoms include, e.g., halogen; oxygen; sulfur; nitrogen; phosphorus.

The random copolymer may be characterized by its molecular weight, specifically its number average molecular weight Mₙ. The Mₙ may be determined using gel permeation chromatography with a multi-angle light scattering detection as described in the Example below. Various Mₙs may be achieved by using an appropriate amount of an initiator to induce the polymerization reactions between monomers. The Mₙ of the random copolymer may be in a range of from 40 kg/mol to 210 kg/mol. In embodiments, the Mₙ of the random copolymer may be in a range of from 40 kg/mol to 80 kg/mol, from 40 kg/mol to 70 kg/mol, or from 40 kg/mol to 60 kg/mol. Random copolymers having a Mₙ within any of these ranges may be referred to as “unentangled” random copolymers as described in the Example, below. The Mₙ of the random copolymer may be in a range of from 135 kg/mol to 210 kg/mol, from 140 kg/mol to 180 kg/mol, or from 150 kg/mol to 170 kg/mol. Random copolymers having a Mₙ within any of these ranges may be referred to as “entangled” random copolymers as described in the Example, below. As also described in the Example, below, the present disclosure provides relatively low Mₙ unentangled random copolymers and relatively high Mₙ entangled random copolymers both types which exhibit the ability to self-heal.

The random copolymer may be characterized by its T_{g}. The T_{g} refers to the midpoint temperature of the glass transition breadth measured for the random copolymer which may be determined using differential scanning calorimetry (DSC) as described in the Example, below. Because a relatively broad range of amounts of the branched alkyl (meth)acrylate may be used, a relatively broad range of T_{g} values may be achieved. The T_{g} of the random copolymer may be in a range of from −30° C. to 20° C. This includes from −25° C. to 15° C., and from −15° C. to 15° C.

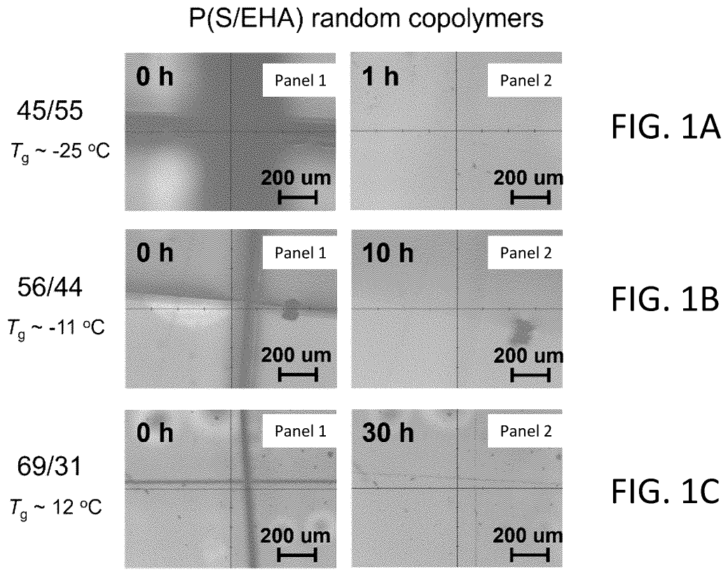

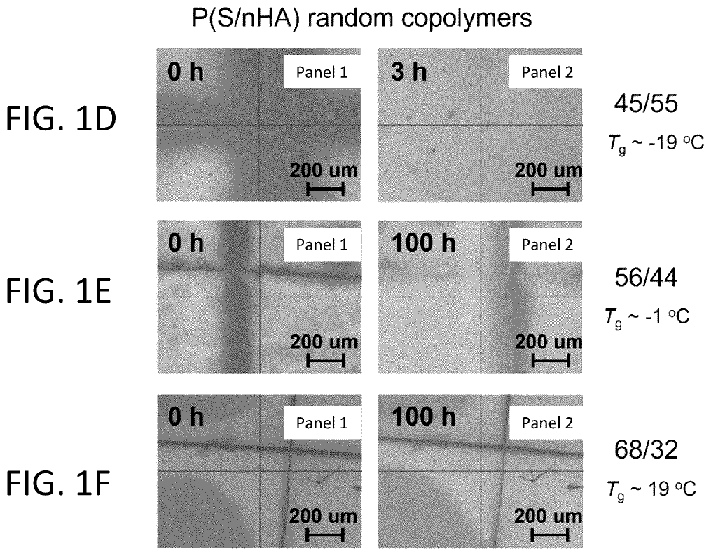

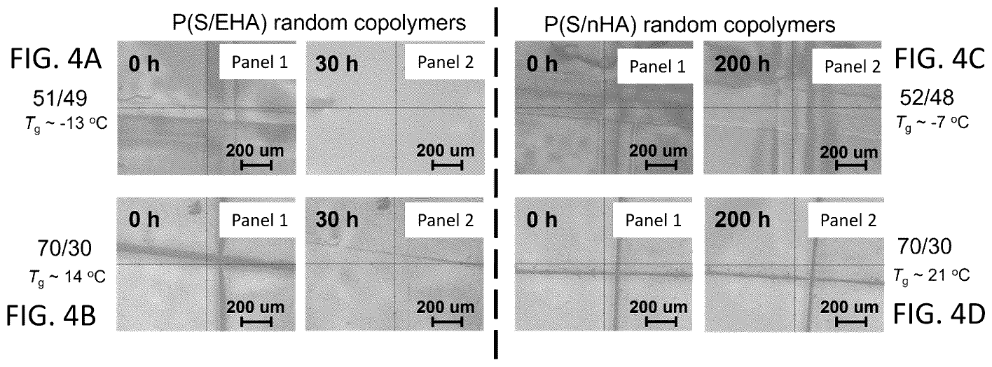

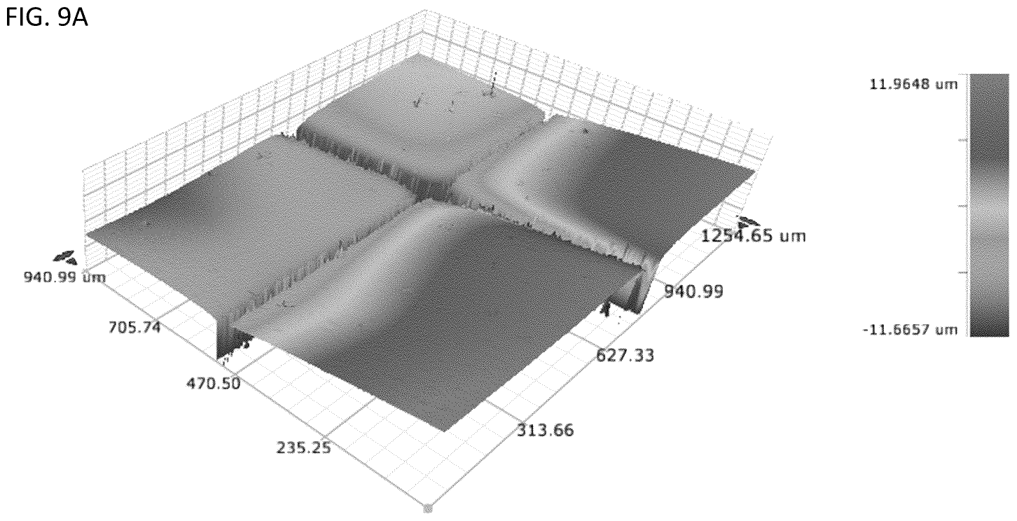

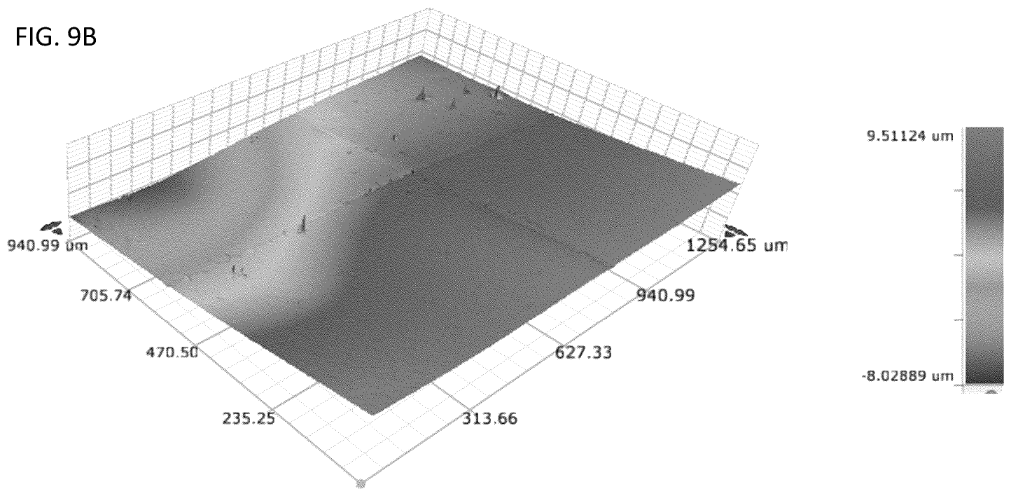

As noted above, the present random copolymers exhibit the ability to self-heal. This includes the ability to self-heal absent any external stimulus and under ambient conditions. This type of self-healing may be referred to herein as autonomous self-healing. Self-healing (including autonomous self-healing) refers to the ability of the random copolymer to recover its native morphology and/or its native property after being subjected to an external force that alters the native morphology/property, including that which creates a defect in the random copolymer. By “native” it is meant prior to receiving the external force. The defect may be a partial or complete cut through the random copolymer. “Recovery” can refer to placing cut surfaces of the random copolymer in contact with one another for a period of time (e.g., no more than 40 hours, no more than 30 hours, no more than 20 hours, no more than 10 hours, or a range between any of these values). “Recovery” can further refer to the contact being conducted under ambient conditions. Autonomous self-healing of illustrative random copolymers as evidenced by optical microscopy is demonstrated in FIGS. 1A-1C and 4A-4B and as evidenced by white light interferometry is demonstrated in FIGS. 9A-9B. By contrast, lack of autonomous self-healing of comparative random copolymers is demonstrated in FIGS. 1E-1F and 4C-4D.

Self-healing (including autonomous self-healing) may be quantified by reference to a healing efficiency as defined by Equation 1 and determined from tensile stress-strain tests conducted as described in the Example, below. Autonomous self-healing of the present random copolymers may be evidenced by a healing efficiency of at least 75%, at least 85%, at least 95%, at least 100%, or a range between any of these values. These values may refer to those obtained by self-healing under ambient conditions for a period of no more than 10, 20, or 30 hours as described in the Example, below. By contrast, lack of autonomous self-healing of comparative random copolymers is evidenced by a healing efficiency of less than 40%. This value may refer to that obtained by self-healing under ambient conditions for a period of at least 100 hours as described in the Example, below.

The random copolymers (and compositions thereof) may be used in any application, including those in which the ability to self-heal, including autonomously self-heal, is a desired property.

One such application involves using any of the present random copolymers (or compositions thereof) to protect a surface (e.g., of an object) in contact therewith. An illustrative such a method comprises applying any of the disclosed random copolymers to the surface to form a treated surface. The method may further comprise applying an external force to the applied random copolymer to create a defect therein, wherein the random copolymer self-heals after a period of time optionally, under ambient conditions. The self-healing effectively eliminates the defect to restore the random copolymer to its native form and having its native properties, thereby protecting the underlying surface.

In embodiments, the random copolymer is poly(styrene-r-2-ethylhexyl acrylate). In embodiments, the 2-ethylhexyl acrylate is present in the random copolymer at an amount in a range of from 40 mol % to 75 mol %, with the balance being composed of styrene. In embodiments, the Mₙ of the random copolymer is in a range of from 40 kg/mol to 210 kg/mol. As demonstrated in the Example, below, it is surprising that the random copolymer according to these embodiments exhibits autonomous self-healing over this broad range of compositions and molecular weights. This is by contrast to the otherwise chemically and structurally similar random copolymer, poly(styrene-r-n-butyl acrylate).

### Example

### Introduction

This Example reports that the random copolymer poly(styrene-r-2-ethylhexyl acrylate) (P(S/EHA)) exhibits self-healing characteristics across a broad range of compositions, including those substantially different from a 50/50 mol ratio. This is attributed to the special nature of the side group of 2-ethylhexyl acrylate (EHA), with its branched side chain providing an alternating ethyl and butyl sequence, potentially leading to interdigitation. This distinctive feature sets this comonomer apart from other commodity n-alkyl acrylates and methacrylates and provides for a range of interesting behavior in EHA-containing copolymers. In the present Example, the self-healing capacity of P(S/EHA) and poly(styrene-r-n-hexyl acrylate) (P(S/nHA)) copolymers has been compared, including high number-average molecular weight (140 kg/mol≤Mₙ≤174 kg/mol), entangled systems and low number-average molecular weight (45 kg/mol≤Mₙ≤71 kg/mol), unentangled systems with molar compositions ranging from 45/55 to 70/30 and glass transition temperature (T_{g}) from −25° C. to 21° C. Low molecular weight (MW) P(S/nHA) demonstrates room-temperature self-healing properties only at the 45/55 composition with T_{g}=−19° C.; high MW P(S/nHA) does not exhibit significant room-temperature self-healing at any tested composition. In contrast, P(S/EHA) copolymers exhibit excellent room-temperature self-healing for all compositions and MWs tested; e.g., the low MW copolymer with 45 mol % styrene and 55 mol % EHA and T_{g}=−25° C. fully self-heals in 1 h, and the high MW, entangled copolymer with 70 mol % styrene and 30 mol % EHA and T_{g}=14° C. fully self-heals in 30 h. Moreover, infrared spectroscopy reveals that the reorientation of the EHA units drives the healing process, and thermal analysis of the glass transition shows greater dynamic heterogeneity in P(S/EHA) than P(S/nHA), indicating special associations formed by EHA units.

### Experimental

Materials and synthesis: Toluene and methanol were purchased from Fisher Chemical. Styrene, calcium hydride, and azobisisobutyronitrile (AIBN) were purchased from Sigma-Aldrich. Additionally, 2-ethylhexyl acrylate and n-hexyl acrylate were acquired from TCI America. Monomers were de-inhibited using inhibitor remover (Aldrich) and dried over calcium hydride overnight before use in synthesis. Random copolymers were synthesized via free radical polymerization, employing AIBN as the initiator at 70° C. In a typical copolymerization, either 10.0 mg (0.061 mmol) or 80.0 mg (0.487 mmol) (depending on the targeted polymer molecular weight) of AIBN was initially dissolved in 5 mL of toluene. After the complete dissolution of AIBN, a total of 0.120 mol of styrene and acrylate comonomers, with varying styrene/acrylate ratios, were added to the toluene solution and thoroughly mixed. The copolymerization proceeded at 70° C. for ˜6 h (10.0 mg or 0.061 mmol AIBN) or ˜2 h (80.0 mg or 0.487 mmol AIBN). Fractional conversion was maintained below 20% to avoid significant composition drift. Polymers were collected by precipitation in methanol. The collected polymers were redissolved in toluene and precipitated again in methanol. This precipitation step was repeated three times to remove unreacted monomer and initiator. Subsequently, polymers were dried in a vacuum oven at 110° C. for 24 h. Before further testing, polymers were molded into 0.070-cm-thick films using a PHI press (Model 0230C-X1) at 80° C. with 10-ton ram force (˜16 MPa).

Characterization: The copolymer composition was determined by proton nuclear magnetic resonance (¹H NMR) spectroscopy (Bruker Avance III HD 500 MHz NMR) with chloroform-d as the solvent.

The copolymer molecular weight was determined by gel permeation chromatography with a multi-angle light scattering detection (GPC-MALS, Agilent 1200 series HPLC system with Wyatt HELEOS II multi-angle laser light scattering and T-rEX refractive index detectors), tetrahydrofuran (THF) as the mobile phase, and a column set consisting of one Shodex KF-807L column and one Shodex KF-805L column in series. The mobile phase flow rate is 1 mL/min, and sample injection volume is 100 μL. The sample concentrations were around 2 mg/mL in THF. Refractive index increment (dn/dc) values of the copolymers were estimated using the weight-averaged values of homopolymer dn/dc values (0.185 mL/g for PS, 0.068 mL/g for PEHA, and 0.065 mL/g for PnHA). The reported values are average numbers of two injections.

Optical self-healing tests: 1.0*1.0*0.070 cm films were placed between two 0.020-cm-thick glass slide spacers and cut using a fresh PTFE-coated stainless steel razor blade, resulting in a cut ˜0.050 cm in depth. Damaged films were placed in a clean, covered petri dish to avoid potential contamination and allowed to heal under ambient conditions. The self-healing process was monitored using a Bruker CounterGT Optical Profiler. Optical images were captured using the microscope on the profiler. White light interferometry was performed with a back distance of 100 mm and a forward distance of 150 mm.

Mechanical self-healing tests: 0.070 cm-thick films were cut into strips ˜0.5 cm wide and ˜1.5 cm long. Films were cut into two pieces at the midpoint, and the two halves were immediately repositioned for healing. Self-healing was conducted at ambient conditions without external pressure. After a specific healing period, tensile stress-strain tests were performed at room temperature using the MTS Criterion Electromechanical Test System. The strain rate for all tests was set to 2.5 mm/s, utilizing a 2.5 kN loading cell. Tensile tests were also performed on undamaged films and films immediately after damage for comparison purposes. Tensile tests were conducted three times using different samples for each self-healing test.

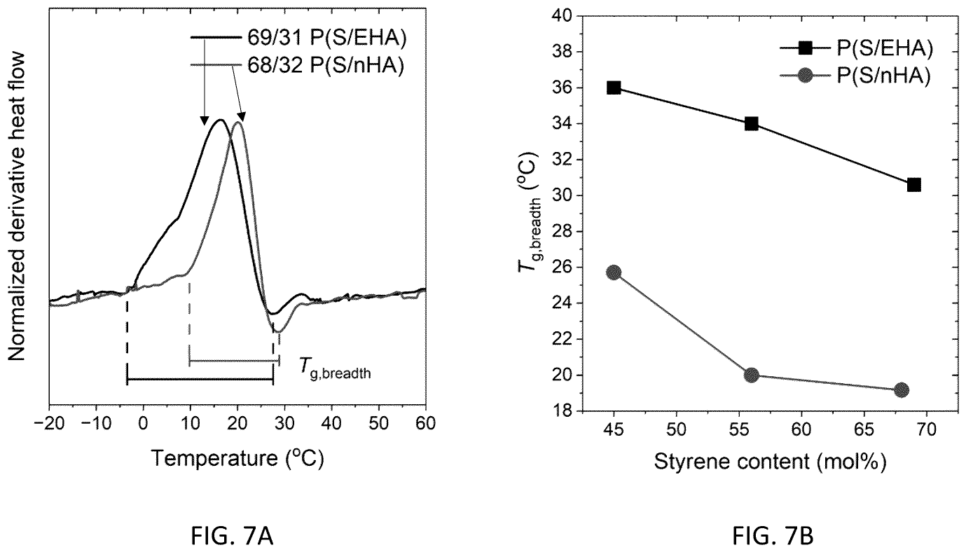

The glass transition behavior of copolymers was characterized using differential scanning calorimetry (DSC) using a Mettler Toledo DSC822e. In a typical DSC measurement, samples weighing 6.0 mg to 12.0 mg were first heated to and held at 100° C. for 20 min to eliminate thermal history, followed by rapid cooling to −80° C. at a rate of −50° C./min. Samples were then equilibrated at −80° C. for 10 min before heating to 100° C. at a rate of 10° C./min. The second heating curve was normalized to sample weight to calculate the derivative heat flow as a function of temperature. The derivative heat flow was normalized to the peak value for comparison. The reported T_{g} is the midpoint temperature of the entire glass transition breadth (see FIG. 7A for a depiction of T_{g} breadth).

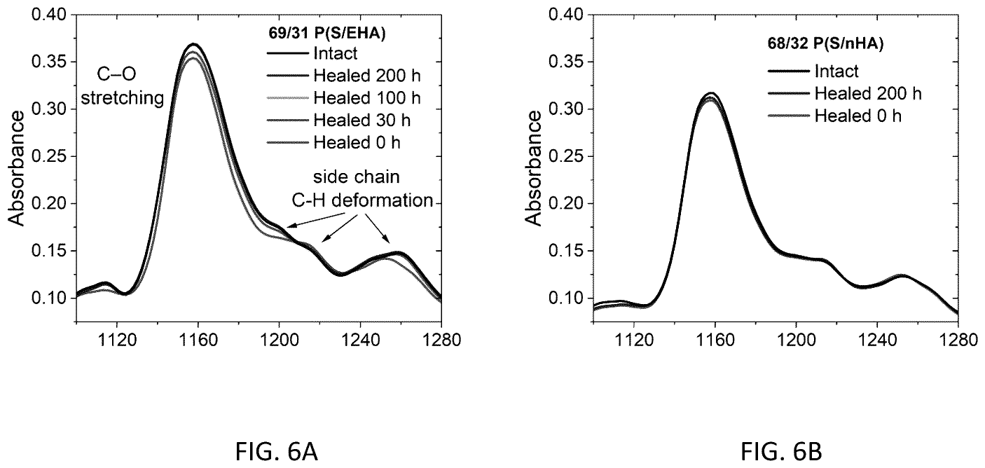

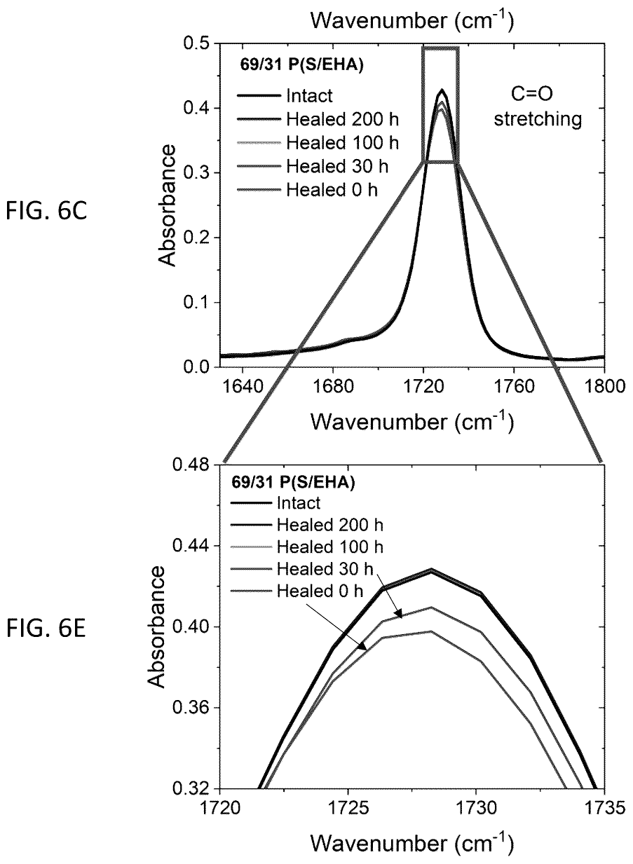

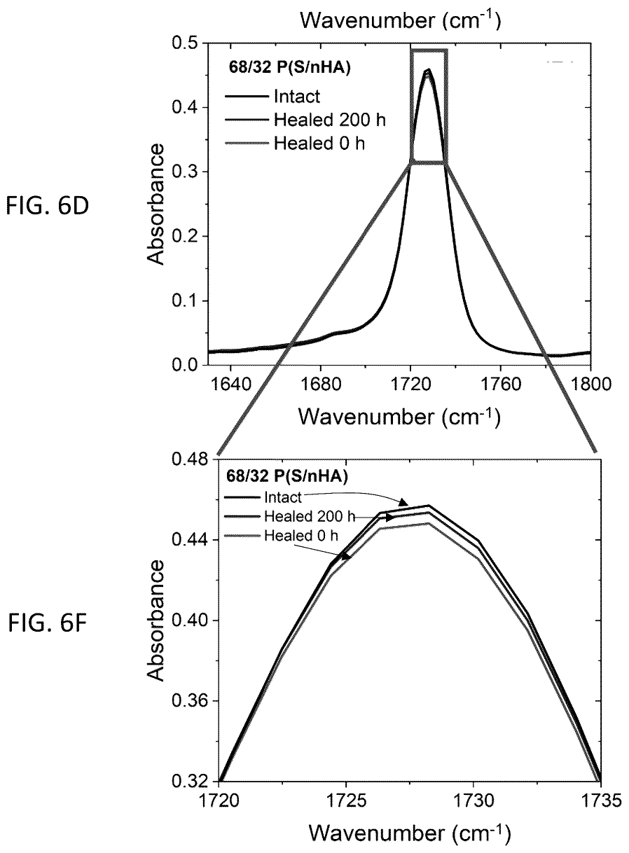

Fourier transform infrared (FT-IR) spectra were obtained using a BrukerTensor37 MiD IR FT-IR spectrophotometer in attenuated total reflectance mode. An average of 64 scans over the 4000-600 cm⁻¹ range with a 4 cm⁻¹ resolution was used to generate a spectrum. FT-IR spectra were initially collected from intact samples measuring 1.0*1.0*0.070 cm. Subsequently, spectra from damaged samples, healed for various durations, were obtained through the following procedure: 0.070-cm-thick copolymer films were initially cut into 0.3*0.3 cm samples and further cut into 256 pieces by 7*7*3 cuts. FT-IR spectra were collected from samples immediately after damage, and samples were allowed to heal for a specified period under ambient conditions. Each spectrum depicted in FIGS. 6A-6F represents an average of three samples.

Atomic force microscopy (AFM) samples were prepared by spin coating 69/31 P(S/EHA)/toluene solutions onto silicon wafers. The spin-coated film thickness was approximately 500 nm, determined by spectroscopic ellipsometry (J.A. Woollam Co., M-2000D). A SPID Bruker Fastscan AFM was used in tapping mode to examine the surface morphology of the polymer film.

### Results and Discussion

This Example describes the synthesis and testing of the room-temperature self-healing capacities of P(S/EHA) and P(S/nHA) copolymers with various molar compositions, ranging from 45/55 to 70/30, at both relatively low MWs (44 kg/mol≤Mₙ≤62 kg/mol) and high MWs (137 kg/mol≤Mₙ≤206 kg/mol), the latter enabling an examination of how chain entanglement impacts self-healing behavior. Schematic chemical structures and detailed information about these copolymers, including T_{g} values, are provided in Table 1. Initially, the self-healing properties of copolymers with M=˜50 kg/mol were examined for a direct comparison with P(S/nBA) copolymers that were made with a similar, low Mₙ. As illustrated in FIGS. 1A-1C, optical images demonstrate that all tested compositions of P(S/EHA) copolymers can effectively self-repair cross-cut damage when allowed to heal under ambient conditions. The time required for complete healing increases from 1 h to 10 h and further to 30 h as the EHA content decreases from 55 mol % to 44 mol % and then to 31 mol %, and the T_{g} increases from −25° C. to −11° C. and then to 12° C., respectively. Optical images for the P(S/nHA) copolymers are shown in FIGS. 1D-1F. In stark contrast, with the low MW P(S/nHA), only the 45/55 composition with T_{g}=−19° C. can self-repair the cross-cut damage, which requires 3 h. In contrast, low MW 56/44 P(S/nHA) and 68/32 P(S/nHA) exhibit weak or no self-repair, even after an extended time period (100 h). This highlights that low MW P(S/nHA) copolymers follow a self-healing pattern similar existing low MW P(S/nBA) copolymers, requiring a nearly 50/50 composition for effective self-healing. However, P(S/EHA) copolymers autonomously self-repair without requiring the composition to be nearly 50/50, making this copolymer system significantly more attractive for commercial use.

TABLE 1
Chemical structure, composition, Mₙ, dispersity and T_{g} values of copolymers.

| Copolymer Chemical Structure | Composition^{a} | Mₙ (kg/mol) | Ð | T_{g} (° C.)^{b} |
|---|---|---|---|---|
| 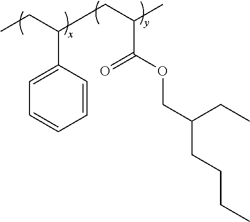 | 45/55 56/44 69/31 51/49 70/30 | 55 50 44 206 169 | 1.92 1.88 1.93 1.87 1.88 | −25 −11 12 −13 14 |
| P(S/EHA) | | | | |
| 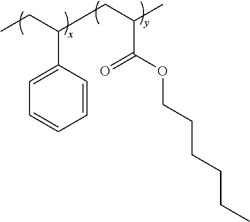 | 45/55 56/44 68/32 52/48 70/30 | 62 49 53 163 137 | 3.98 3.08 2.80 1.63 1.65 | −19 −1 19 −7 21 |
| P(S/nHA) | | | | |

^{a}Copolymer composition is in mol %; e.g., 45/55 P(S/EHA) is 45 mol % S and 55 mol % EHA.
^{b}T_{g} is determined from derivative DSC curves yielding the T_{g} breadth (see FIG. 7), with T_{g} taken
as the T_{g} breadth midpoint.

Alongside optical microscopy, white light interferometry was used to characterize the self-healing of the damage. FIGS. 9A-9B display the three-dimensional reconstruction of the damaged and healed 69/31 P(S/EHA) films. As depicted in FIG. 9B, there is no observable damage to the structural integrity of the 69/31 P(S/EHA) films after self-repair. This highlights the ability of P(S/EHA) copolymers to restore their structural integrity even after severe damage. This phenomenon can be further elucidated through mechanical testing of intact, damaged, and self-healed films.

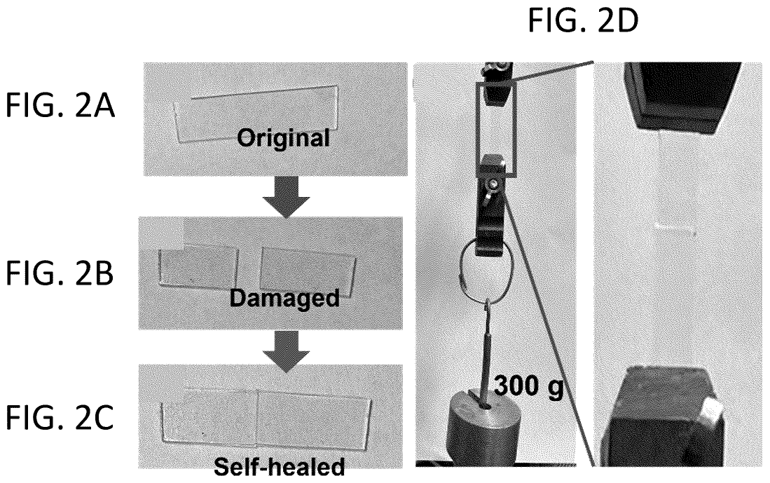

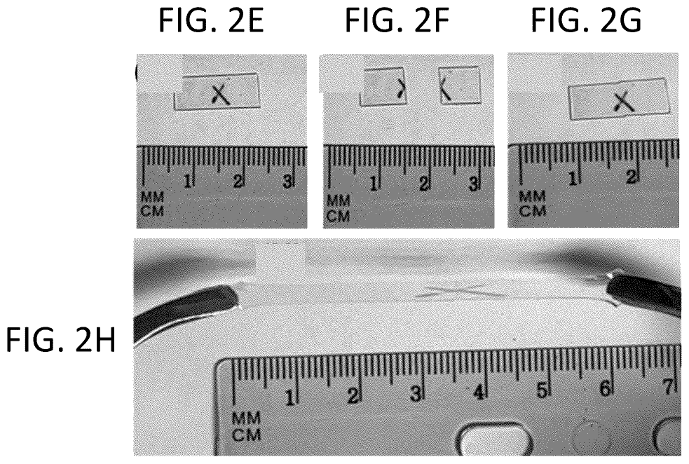

FIG. 2A-2D demonstrate the mechanical robustness of the 69/31 P(S/EHA) materials with Mₙ=44 kg/mol, showcasing the ability of the self-healed film to withstand a 300 g weight (resulting in a stress of 0.5 MPa) without breaking or experiencing significant deformation. Accordingly, FIGS. 2E-2H show that the healed film can endure substantial strain (˜230%) without structural failure.

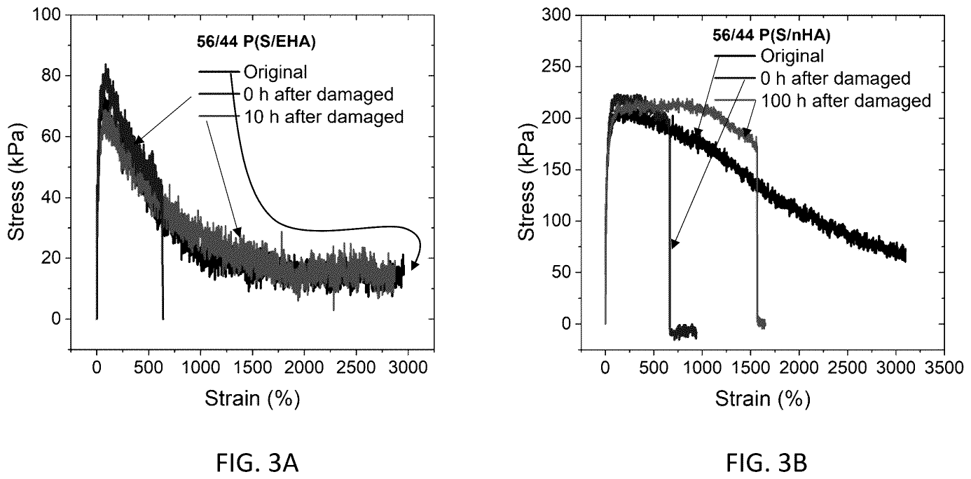

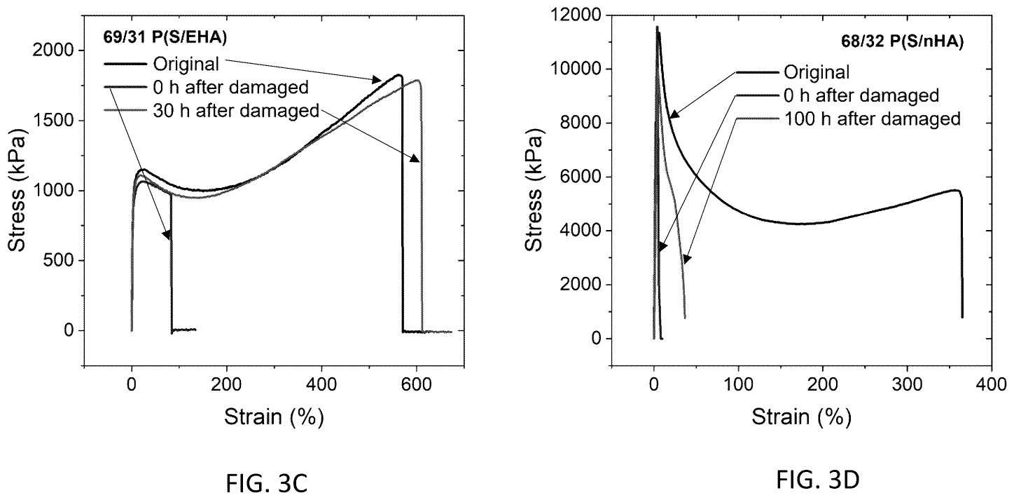

Tensile stress-strain tests were used to rigorously assess the recovery of mechanical properties post-self-healing. In particular, the healing efficiency is calculated from the recovered elongation at break:

$$Healing Efficiency = \frac{{ε}_{heal} - {ε}_{damage}}{{ε}_{orginal} - {ε}_{damage}} \qquad Equation 1$$

where εₕₑₐₗ is the elongation at break for a damaged film allowed to self-heal for a certain amount of time; ε_{damage} is the elongation at break for a damaged film, and ε_{original} is the elongation at break for an undamaged film. As shown in FIG. 3A, 56/44 P(S/EHA) with Mₙ=50 kg/mol exhibits complete recovery of elongation at break and tensile strength after 10 h of self-healing at ambient conditions. In contrast, 56/44 P(S/nHA) with Mₙ=49 kg/mol demonstrates, at most, 35±5% healing efficiency, calculated using Equation 1, after 100 h of ambient-condition self-healing. This trend is consistent across other compositions: 69/31 P(S/EHA) with Mₙ=44 kg/mol displays full recovery of mechanical properties as shown in FIG. 3C after 30 h of ambient-condition self-healing (healing efficiency of 106±11%), whereas 68/32 P(S/nHA) with Mₙ=53 kg/mol exhibits little or no healing after 100 h of ambient-condition self-healing (healing efficiency of 9±4%) as shown in FIG. 3D. Due to their low T_{g} and MW values, conducting room-temperature tensile tests on the 45/55 P(S/EHA) or 45/55 P(S/nHA) copolymers before damage or after healing was impossible. Overall, the mechanical self-healing tests are consistent with the optical self-healing tests.

To evaluate the self-healing capacities of entangled copolymers, P(S/EHA) and P(S/nHA) materials of higher MW, with Mₙ≥137 kg/mol were prepared, and self-healing tests conducted. The distinction between the self-healing capabilities of P(S/EHA) and P(S/nHA) becomes more pronounced in entangled, high MW materials where chain entanglements strongly reduce chain diffusivity. As illustrated in FIGS. 4A and 4B, damaged high MW P(S/EHA) films of 51/49 and 70/30 composition exhibit self-healing after 30 h under ambient conditions. In contrast, and as shown in FIGS. 4C and 4D, even at a 52/48 composition, high MW P(S/nHA) film fails to self-repair after an extremely long time of 200 h.

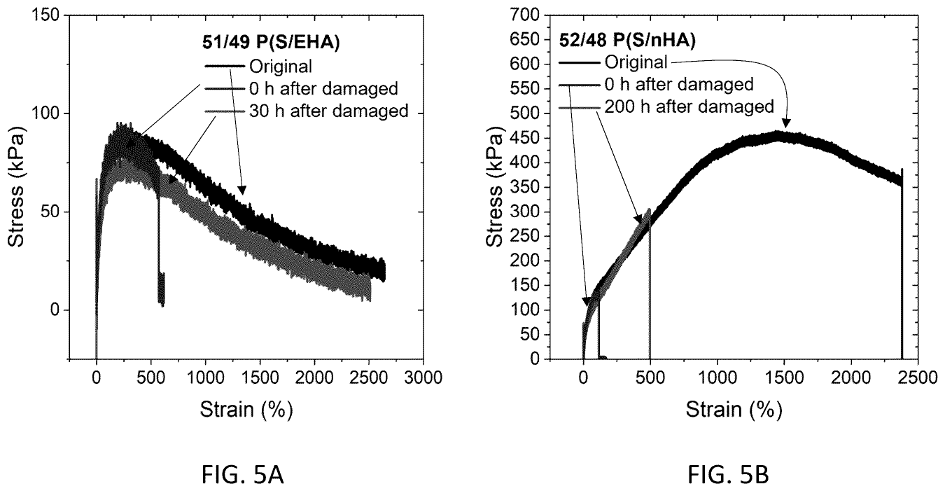

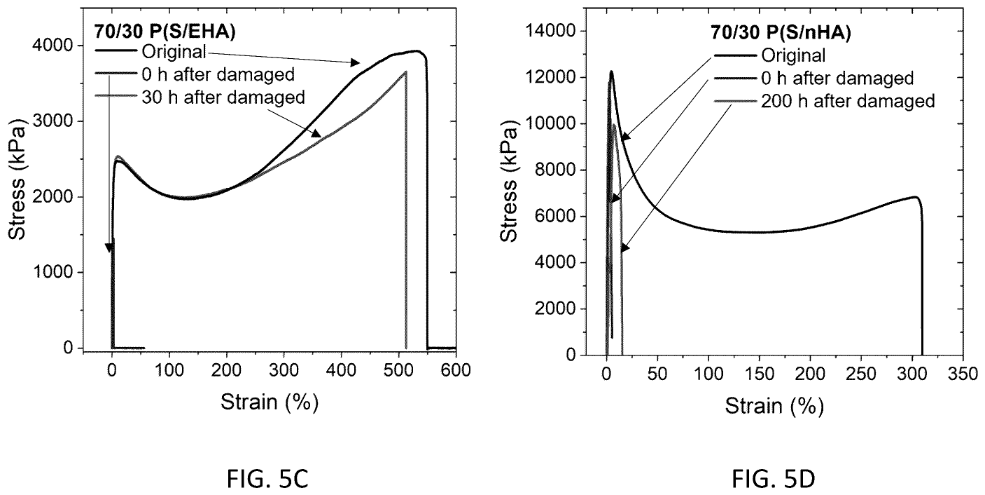

Mechanical self-healing tests for these entangled materials reveal a similar trend. As shown in FIGS. 5A and 5B, 51/49 P(S/EHA) and 70/30 P(S/EHA) with T_{g}s of −13° C. and 14° C., respectively, demonstrate healing efficiencies of 95±5% and 93±11%, respectively, after 30 h of self-healing under ambient conditions. In contrast, and as shown in FIGS. 5C and 5D, 52/48 P(S/nHA) and 70/30 P(S/nHA) exhibit little or no healing, with healing efficiencies measuring 15±5% and 6±2%, respectively.

Overall P(S/EHA) exhibits remarkably enhanced self-healing characteristics compared to both P(S/nHA) and P(S/nBA), performing well in healing damage with only 30 mol % EHA incorporation and a T_{g} as high as 14° C. This suggests that the exceptional self-healing capability of P(S/EHA) likely does not originate from the ‘ring-and-lock’ associations reported in P(S/nBA), which necessitate a composition close to 50/50 for self-healing.

Without wishing to be bound to a particular theory, it is hypothesized that the ethylhexyl groups in EHA side chains on different copolymers can experience substantial van der Waals forces, interdigitate and form ‘key-and-lock’ associations between chains. To better understand the role that the EHA unit plays associated with self-healing, ATR-FTIR analysis was employed on low MW, 69/31 P(S/EHA) samples that were allowed to self-heal for various periods to examine molecular events during the self-healing process.

FIGS. 6A-6F compares the FT-IR spectra in the 1100-1280 cm⁻¹, 1630-1800 cm⁻¹ and 1720-1735 cm⁻¹ regions for intact and damaged, 69/31 P(S/EHA) with Mₙ=44 kg/mol and 68/32 P(S/nHA) with Mₙ=53 kg/mol as functions of self-healing time. In FIGS. 6A and 6B, the strong absorption peak at 1158 cm⁻¹ corresponds to C—O stretching vibrations, and the weak peaks in the 1200-1280 cm⁻¹ region are associated with bending, wagging, twisting, and rocking of C—H bonds on the acrylate side groups. In FIGS. 6C-6F, the pronounced absorption peak at 1728 cm⁻¹ is a result of C═O stretching. As shown in FIGS. 6B, 6D and 6F, after healing under ambient conditions for ˜200 h, 68/32 P(S/nHA) exhibits no or very weak intensity changes in all regions, unable to recover the intensity in intact materials. These very weak intensity changes may also be attributed to the FT-IR spectra being affected by the sample surface smoothness. Conversely, FIGS. 6A, 6C and 6E demonstrate evident and gradual intensity changes in both C═O (1728 cm⁻¹) stretching and C—O (1158 cm⁻¹) stretching bands with self-healing of the 69/31 P(S/EHA) copolymer, consistent with alteration in the local chemical environment. This change is further evidenced by the evolution of the spectral shape of the EHA side-group C—H bond deformations (1200-1280 cm⁻¹ region), as depicted in FIG. 6A, indicating the rearrangement of ethylhexyl side groups into new configurations during self-healing. Notably, the presence of an isobestic point at 1208 cm⁻¹ also implies conformational changes in the EHA side chain. The FT-IR analysis supports the hypothesis that the self-healing behavior of P(S/EHA) is driven by the conformational rearrangement of EHA unit side chains into specific associations consistent with interdigitation.

For 69/31 P(S/EHA), it was observed that the time needed to achieve a time-independent FT-IR spectrum falls between 30 h and 100 h, longer than the time required for optical and mechanical self-healing tests (30 h). This disparity arises from the differing experimental procedures: while optical and mechanical self-healing tests involve a single cut, spectroscopic self-healing tests utilize multiple cuts.

If EHA units can form distinct associations within P(S/EHA) copolymers, such structures could influence the thermal properties of the copolymer. Therefore, the thermal glass transition responses of P(S/EHA) and P(S/nHA) were compared to probe potential associations of EHA units. FIG. 7A presents the DSC-obtained differential heat flow as a function of temperature. As depicted in FIG. 7A, the endpoints of glass transition for 69/31 P(S/EHA) and 68/32 P(S/nHA) are close, 28° C. and 29° C., respectively. However, the onset of the glass transition for 69/31 P(S/EHA) occurs at a temperature that is 13° C. lower than that of 68/32 P(S/nHA), resulting in a glass transition breadth that is 12° C. (or ˜60%) broader for 69/31 P(S/EHA). Moreover, for all acrylate contents considered in this Example, the glass transition breadth of P(S/EHA) is 10° C. to 14° C. larger than that of its closest, P(S/nHA) counterpart.

A broader glass transition in a polymer, often observed in block or gradient copolymers, correlates with local heterogeneity in the dynamics and structures of polymer chains. However, considering the reactivity ratios of styrene/EHA (rₛ˜0.95-0.98, r_{EHA}˜0.29)^{[51]}, the low comonomer conversion (<20%), and the absence of any phase structures observed under the atomic force microscope (image not shown), it is unlikely that the broader glass transition of P(S/EHA) is due to a blocky monomer sequence. Instead, the observed dynamic heterogeneity, particularly the significantly lower glass transition onset temperature, is consistent with the formation of interchain, special nanostructures by EHA units, possibly facilitated by interdigitation under van der Waals forces—a phenomenon not exhibited by nHA units unless the copolymer composition is nearly 50/50 and the copolymer MW is relatively low.

### CONCLUSION

This Example reports the development of an autonomous self-healing random copolymer system driven by the van der Waals interactions of EHA units. While other self-healing copolymers that are driven by van der Waals interactions, such as low MW P(MMA/nBA), P(S/nBA), and P(TFEMA/nBA) (where TFEMA is 2,2,2-trifluoroethyl methacrylate) require a nearly 50/50 molar composition for good autonomous, self-healing character, the P(S/EHA) copolymer exhibits autonomous, room-temperature self-healing across a wide composition range from 45/55 to 70/30 and with T_{g}s ranging from −25° C. to 14° C. Moreover, it was demonstrated that both high MW, entangled and low MW, unentangled P(S/EHA) copolymers possess remarkable self-healing characteristics. In contrast, self-healing in P(S/nHA) copolymers is evident only at a 45/55 composition and at a MW below the entanglement MW. The FT-IR analysis reveals significant conformational changes in EHA units during self-healing. The thermal analysis indicates unusual glass transition breadth for a random copolymer, consistent with the formation of special associations by EHA units in intact samples. It is hypothesized that the driving force behind the self-healing capability is the rearrangement of EHA into interdigitated configurations under van der Waals forces. This study introduces a novel strategy utilizing van der Waals interactions for designing self-healing materials without the need for alternating comonomer sequences.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

In recognition of the inherent nature of electrochemical processes, throughout the present disclosure, terms and phrases such as “absence,” “free,” “does not comprise,” “does not occur,” etc. encompass, but do not require a perfect absence of the referenced entity. The term “type” as used herein refers to chemical formula such that a single type means the same chemical formula and different type means different chemical formula. Similarly, use of “more” as in “one or more” refers to use of different types of the relevant entity. Terms such as “comprising” and the like may be replaced with terms such as “consisting” and the like.

What is claimed is:

1. A self-healing, random copolymer that is a polymerization product of monomers comprising a branched alkyl (meth)acrylate and a comonomer, wherein the branched alkyl (meth)acrylate is present at an amount of at least 40 mol %.

2. The self-healing random copolymer of claim 1, wherein the branched alkyl (meth)acrylate is represented by H₂CCR₁C(O)OR₂, wherein R₁ is hydrogen or methyl and R₂ is a branched alkyl.

3. The self-healing random copolymer of claim 2, wherein the branched alkyl has from 6 to 12 carbon atoms.

4. The self-healing random copolymer of claim 3, wherein the branched alkyl has a single branch.

5. The self-healing random copolymer of claim 4, wherein the branched alkyl contains no heteroatoms.

6. The self-healing random copolymer of claim 1, wherein the branched alkyl (meth)acrylate is selected from 2-ethylhexyl acrylate, 2-ethylhexyl methacrylate, 2-propylheptyl acrylate, 2-propylheptyl methacrylate, and combinations thereof.

7. The self-healing random copolymer of claim 1, wherein the comonomer comprises a vinyl group.

8. The self-healing random copolymer of claim 7, wherein the comonomer is selected from styrene, 4-methylstyrene, an acrylate, a methacrylate, vinyl pyridine, an acrylamide, vinyl acetate, a vinyl alkyl ether, and combinations thereof.

9. The self-healing random copolymer of claim 8, wherein the comonomer is selected from unsubstituted styrene, substituted styrene, and combinations thereof.

10. The self-healing random copolymer of claim 1, wherein the branched alkyl (meth)acrylate is present at an amount in a range of from 40 mol % to 75 mol %.

11. The self-healing random copolymer of claim 1, wherein a balance of the copolymer is made up of the comonomer.

12. The self-healing random copolymer of claim 10, wherein the comonomer is present at an amount in a range of from 25 mol % to 60 mol %.

13. The self-healing random copolymer of claim 1, wherein the monomers consist of the branched alkyl (meth)acrylate and the comonomer, wherein the branched alkyl (meth)acrylate is selected from 2-ethylhexyl acrylate, 2-ethylhexyl methacrylate, 2-propylheptyl acrylate, 2-propylheptyl methacrylate, and combinations thereof, and further wherein the comonomer is selected from styrene, 4-methylstyrene, an acrylate, a methacrylate, vinyl pyridine, an acrylamide, vinyl acetate, a vinyl alkyl ether, and combinations thereof.

14. The self-healing random copolymer of claim 13, wherein the copolymer is poly(styrene-r-2-ethylhexyl (meth)acrylate).

15. The self-healing random copolymer of claim 1, characterized by a number average molecular weight Mₙ in a range of from 40 kg/mol to 210 kg/mol.

16. The self-healing random copolymer of claim 15, wherein the Mₙ is in the range of from 40 kg/mol to 80 kg/mol.

17. The self-healing random copolymer of claim 1, characterized by a healing efficiency of at least 75%, as measured from a tensile stress-strain test conducted after cutting the self-healing random copolymer into two pieces and placing the two pieces in contact with each other under ambient conditions for a period of no more than 30 hours.

18. The self-healing random copolymer of claim 1, having a Formula 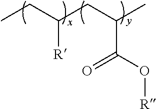
wherein R′ is selected from phenyl, ester, pyridine, amide, acetate, and alkoxy and R″ is selected from branched alkyls.

19. A composition or a composite comprising the self-healing random copolymer of claim 1.

20. A method of using the self-healing random copolymer of claim 1, the method comprising applying the copolymer to a surface to form a treated surface.
